(19) United States
(12) Patent Application Publication
(10) Pub. No.: US 2015/0286200 A1
(43) Pub. Date: Oct. 8, 2015

(54) Device for an Optimized Operation of a Local Storage System in an Electrical Energy Supply Grid with Distributed Generators, Distributed Storage Systems and Loads

(71) Applicant: Caterva GmbH, Pullach (DE)

(72) Inventors: Kolja Eger, Ottobrunn (DE); Roland Gersch, Muenchen (DE); Joerg Heuer, Oberhaching (DE); Martin Winter, Rosenheim (DE)

(21) Appl. No.: 14/416,589

(22) PCT Filed: Jul. 31, 2012
(86) PCT No.: PCT/EP2012/064927

§ 371 Date: Jun. 2, 2015

(51) Int. Cl. G05B 19/048

(52) U.S. Cl. CPC G05B 19/048; G05B 2219/24136; G05B 2219/2639

(57) ABSTRACT

The invention essentially relates to a device for an optimized operation of a local storage system in an electrical energy supply grid connecting distributed generators and distributed loads, in which a storage control unit for the local storage system is present such that, local values are measurable at the local storage and are transmittable to the operator side, locally stored internal installation-dependent control limits are transmittable to the operator side, operational control parameters and/or control limits are receivable from the operator side and a charge/discharge current of the local storage is optimally adjustable at a given point in time by a search of a minimum of a cost function on the basis of the local values, the locally stored internal installation-dependent control limits and the operational control parameters and/or control limits.

The invention relates to a device for an optimized operation of a local storage system, e.g. a charge storage in the form of an accumulator but also a thermal storage or a gas storage, in an electrical supply grid connecting distributed generators, for example photovoltaic systems, and distributed loads.

The importance of renewable energy sources is increasing, wherein these energy sources are distributed and are difficult to predict in terms of the amount of energy they can deliver because, by way of example in photovoltaic systems, there is a dependency on the weather. This leads to stability and capacity problems in corresponding electrical power supply grid.

One solution to these problems lies in distributed energy or charge storage devices. Such storage devices are relatively expensive, however, and most be deployed effectively, for example by serving multiple applications from one storage device.

The underlying object of the invention now consists of specifying a device for an optimized operation of a local storage system in an electrical energy supply grid with distributed generators, distributed storage systems and loads such that, taking into account the locally restricted availability of energy and power and the boundary conditions resulting from serving multiple applications from one storage system, such as ensuring the power availability, a cost function for the local storage, e. g. the lifetime of the local storage system within an energy supply grid, is optimized.

This object is achieved in accordance with the invention by the features of claim 1. The further claims relate to preferred embodiments of the invention.

The invention essentially relates to a device for an optimized operation of a local storage system in an electrical energy supply grid with distributed generators, distributed loads and distributed storage devices, in which a storage control unit for the local storage device is present such that, local values are measurable at the local storage and are transmittable to the operator side, locally stored internal installation-dependent control limits are transmittable to an operator side, operational control parameters and/or control limits are receivable from the operator side and a charge/discharge current of the local storage is optimally adjustable at a given point in time by a search of a minimum of a cost function on the basis of the locally-measured values, the locally stored internal installation-dependent control limits and the operational control parameters and/or control limits.

The invention will be explained below on the basis of exemplary embodiments presented in the drawing, in which

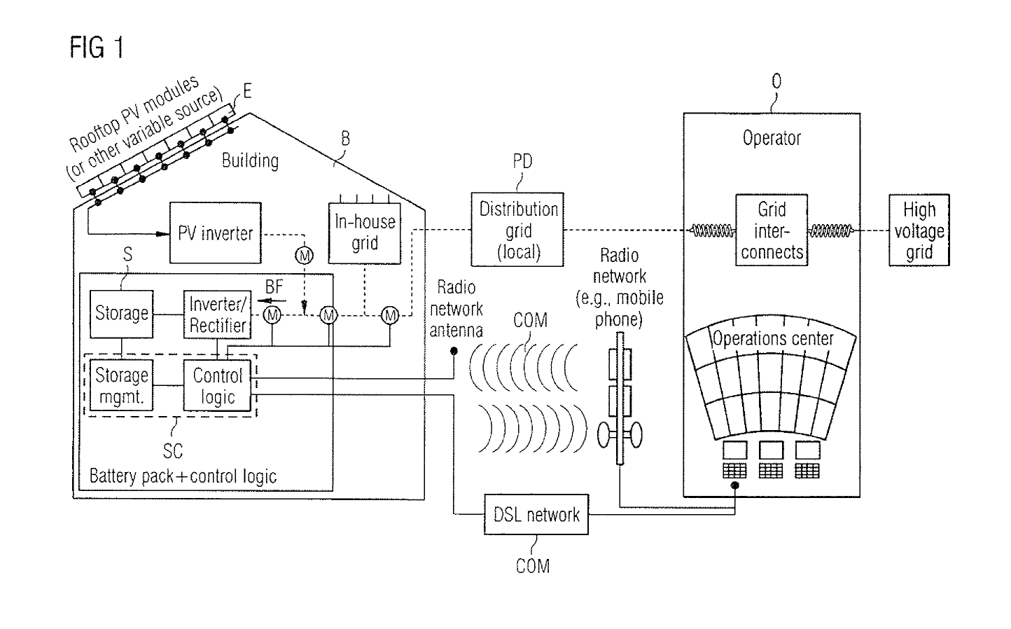

FIG. 1 shows an overview diagram to explain the environment of the inventive device,

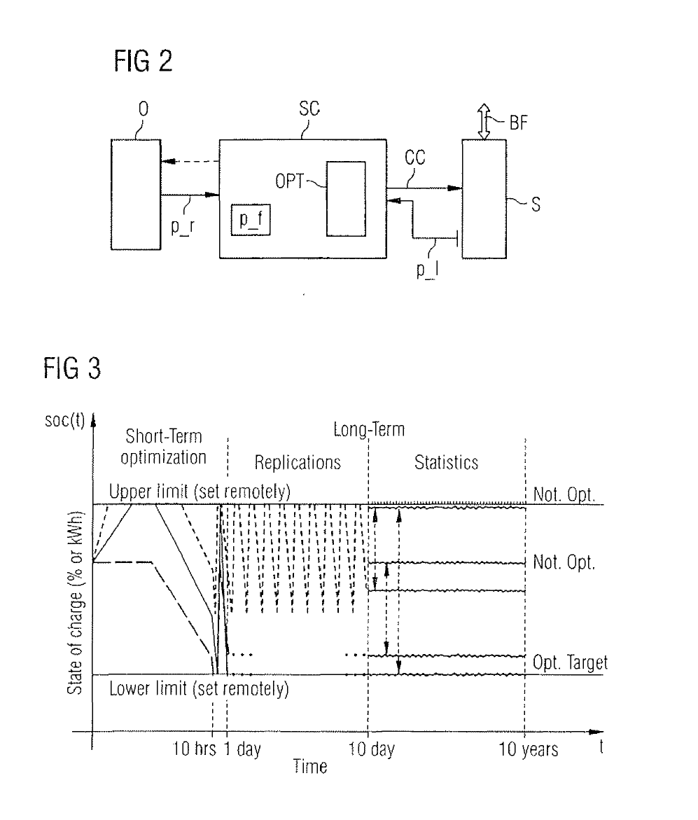

FIG. 2 shows a basic diagram to explain the inventive device,

FIG. 3 shows a diagram illustrating the functioning of the inventive device and

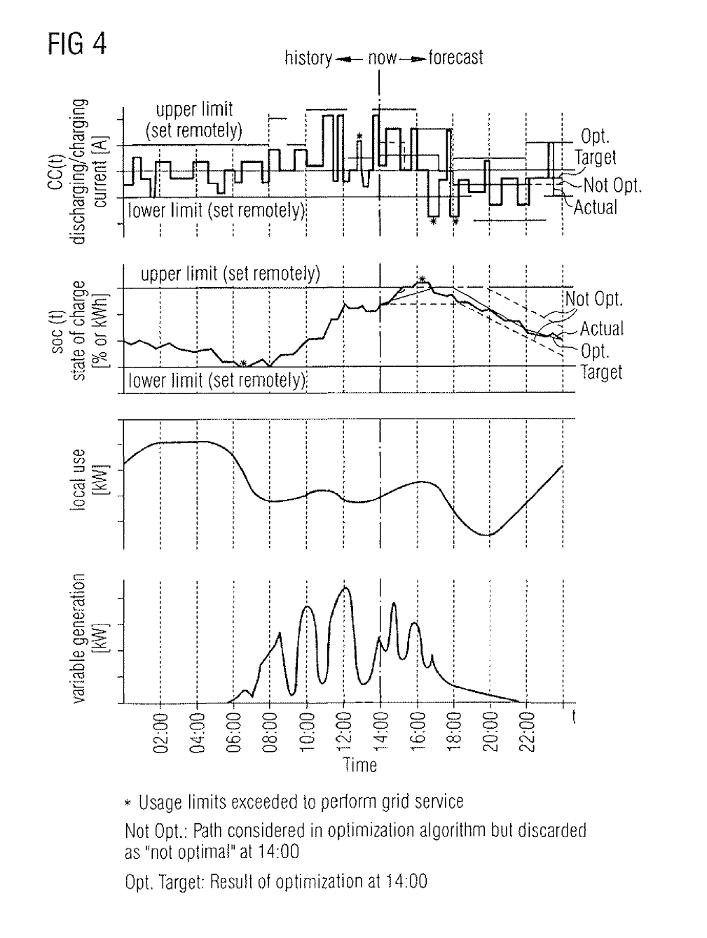

FIG. 4 shows a further diagram to explain the functioning of the inventive device.

FIG. 1 shows an overview diagram to explain the background of the inventive device with a building B, on the roof of which a local generator E is present in the form of photovoltaic cells and in which, as well as ancillary units such as inverters/rectifiers and measurement devices M, a local storage system S with a charge/discharge current BF, for example an accumulator, and a storage control unit SC are located. This building B is connected for power distribution via a local power distribution grid PD to further buildings, storage systems, power generators and loads and is also connected to an operations center O for communication, for example via DSL or mobile radio. Apart from a plain storage device the local storage system S also includes at least units like power electronics, control unit and battery management system.

FIG. 2 shows a basic diagram to explain the inventive device in the term of a local storage control unit SC being connected to a corresponding local storage system S and to the operation center O. The control unit SC is calculating a setpoint CCT of the charging/discharging current BF for the storage system S, comprises a local optimizer OPT and is connected in such a way that local values p_l are measurable at the location of the storage system S and transmittable to the operator side O, locally stored internal installation-dependent control limits p_f are transmittable to the operator side O and operational control parameters and/or control limits p_r are receivable from the operator side O.

The control unit SC is advantageously formed such that the charge/discharge current BF of the local storage S shown in FIG. 1 is optimally adjustable at a given point in time by a search of a minimum of a cost function on the basis of the local values p_l, the locally stored internal installation-dependent control limits p_f and the operational control parameters and/or control limits p_r.

In a preferable embodiment the cost function, which is to be minimized, corresponds to a service life, which is to be maximized, of the local storage system S and this service life is determinable at least from the usage history h([0, t]) of the storage system and a usage history/storage system service life model for the storage system.

The remaining storage capacity cap_h(t) is determinable from the respective usage history h([0, t]) and a usage history/storage capacity model for the local storage system S. In this case the service life of the local storage system S is attainable if at least the remaining storage capacity cap_h(t) does not fall below a certain critical storage capacity.

The usage history h([0, t]) advantageously comprises accumulated previous charging profiles c(t, (soc_i, soc_f, CC)), wherein these include the number of charging and/or discharging processes of the storage system that have occurred from a specific initial charging state soc_i to a specific end charging state soc_f and with a specific charging current CC after a specific operating period t.

Optionally the remaining storage capacity cap(t) is formable in that a percentage, which is calculated by weighted integration of the accumulated previous charging profiles c(t, (soc_i, soc_f, CC)) over the range of all possible triples comprising initial charging states, end charging states and charging/discharging currents, is subtracted from 100%, wherein the weighting function w also depends on the triples (soc_i, soc_f, CC) and on the storage model.

Optionally an increase in internal resistance r_h(t) is determinable from the usage history h([0, t]) and a usage history/increase in internal resistance model for the storage system S and the service life of the local storage system S is exceeded at least when the local storage system can no longer absorb and/or deliver a specific critical wattage due to the increase in internal resistance.

The operational control parameters and/or control limits p_r, which are to be conveyed using communications technology, for the local storage system S include advantageously at least information about a maximum charging/discharging current limit and/or information about minimum and maximum charging states for local operation and/or maximum charging/discharging current limits for local operation and/or a default value for a charging/discharging current and/or information about electrical grid service requirements.

The measured values p_l(t) locally determined at the local storage system S include advantageously at least one measured time serie or value for voltage frequency and/or voltage and/or spectra of the voltage and therewith the voltage frequency and/or locally generated current and/or locally consumed current and/or local charge state and/or local charging/discharging current and/or electrical grid voltage and/or temperature at at least one location.

The locally stored internal installation-dependent control limits p_f(t) include advantageously at least one maximum charging/discharging current and/or maximum and minimum charging states.

Optionally an optimal charging/discharging current cc(t) can be approximated by a combination of a detailed short-term consideration within a first time interval [t, t+Delta], e.g. by using a simulation, and a long-term consideration within a following second time interval [t+Delta,L], e.g. by using a repetition of part statistics.

The short-term consideration optionally comprises a short-term prediction of expected operational control parameters and/or control limits p_r ([t, t+Delta]) and a variation of the possible charging/discharging current progressions cc([t, t+Delta]) under the condition of the predicted operational control parameters and/or control limits p_r ([t, t+Delta]) and/or the locally stored internal installation-dependent control limits p_f(t).

The variation is advantageously performable by a weighted average of a set of randomly chosen representative progressions of charging/discharging current cc([t, t+Delta]) taking into account the predicted operation control parameters and/or control limits p_f ([t, t+Delta]) and/or the locally stored internal installation-dependent control limits p_f(t) and assigning higher weights to those representative charging/discharging current curves with more favorable cost function values.

The long-term consideration within the second time interval [t+Delta,L] is advantageously performable by a combination of several representative cost functions within a time interval being shorter than the second time interval.

The long-term consideration is also advantageously performable on the basis of results of the short-term consideration.

FIG. 3 shows a diagram to explain an example of feeding the results of a short-term optimization as illustrated in FIG. 4 back onto the long-term behavior of the storage respectively the battery. The curves generated by the short-term optimizer plus the history of the day so far are repeated for 10 days, with the control limits cutting the curves off where applicable by reducing the charging or discharging current to zero. A statistic is generated and scaled onto a timeframe of 10 years.

In the optimization, the following is considered better if two progressions are compared:
higher remaining capacity and lower internal resistance of the storage system after 10 years as calculated by a model for the storage system's aging processes
employing more energy from the variable generation for local use.

FIG. 4 shows a diagram to illustrate a simple version of the optimization of the operation of an individual storage system under control limits imposed remotely. The control limits are a maximum charging and a maximum discharging current for local usage and a maximum and minimum state of charge for local usage. These limits change over time.

In this example, at 14:00, the optimizer searches the optimal state-of-charge curve for the following ten hours. In the optimization, the following is considered better if two progressions are compared:
drawing more power from the variable generation for local use
keeping lower maximal charging currents
keeping lower maximal discharging currents

The optimizer OPT has forecasts for local use and variable generation. Electrical energy supply grid services to be performed are taken into account only by staying within the control limits which are set remotely, since the necessity of grid services is assumed not to be predictable in this case. The result of the optimization is the solid curve. The dashed curves are intermediate steps in the optimization. In a Monte Carlo optimization, these curves would be assigned a significantly lower integration weight than the solid path.

In FIG. 4 the optimal progression in the short-term also generates optimal results in the long term. However it should be noted that depending on the weights of the two optimization criteria above, the optimizer could also find the dashed curve which is actually sketched for the long term to be optimal if the storage system ages much less when spending most of its life at a higher state of charge.

1-14. (canceled)

15. A device (SC) for an optimized operation of a local storage system (S) in an electrical energy supply grid with distributed storages, wherein there is a storage control unit (SC) for the local storage system (S) in such a way that
local values (p_l) are measurable at the local storage and are transmittable to the operator side (O),
locally stored internal installation-dependent control limits (p_f) are transmittable to the operator side,
operational control parameters and/or control limits (p_f) are receivable from the operator side and
a charge/discharge current (BF) of the local storage system (S) is optimally adjustable at a given point in time by a search of a minimum of a cost function on the basis of the local values (p_l), the locally stored internal installation dependent control limits (p_f) and the operational control parameters and/or control limits (p_r)

16. The device as claimed in claim 15, wherein the cost function, which is to be minimized, corresponds to a service life, which is to be maximized, of the local storage system (S) and wherein this service life is determinable at least from usage histories (h([0,t])) of the storage system and a usage histories/storage system service life model for the storage system.

17. The device as claimed in claim 16, wherein the remaining storage capacity (cap_h(t)) is determinable from the respective usage histories (h([0,t])) and a usage histories/storage capacity model for the local storage system (S) and wherein the service life of the local storage system (S) is attainable if at least a determined remaining storage capacity (cap_h(t)) does not fall below a certain critical storage capacity.

18. The device as claimed in claim 17, wherein the usage history (h([0,t]) comprises accumulated previous charging profiles (c (t, (soc_i, soc_f, CC))), wherein these include the number of charging processes of the storage system that have occurred from a specific initial charging state to a specific end charging state and a specific charging current (CC) after a specific operating period (t).

19. The device as claimed in claim 18, wherein the remaining storage capacity (cap(t)) is formable in that a percentage, which is calculated, by weighted integration of the accumulated previous charging profiles (c (t, (soc_i, soc_f, CC))), over the range of all possible triples comprising initial charging states, end charging states and charging/discharging currents, is subtracted from 100%, wherein the weighting function (w) also depends on these triples and on the storage model.

20. The device as claimed in claim 16, wherein an increase in internal resistance (r_h(t)) is determinable from the usage history (h([0,t])) and an usage history/increase in internal resistance model for the storage system (S) and wherein the service life of the local storage system (S) is at least when the local storage system can no longer absorb and/or deliver a specific critical wattage due to the increase in internal resistance.

21. The device as claimed in claim 17, wherein an increase in internal resistance (r_h(t)) is determinable from the usage history (h([0,t])) and an usage history/increase in internal resistance model for the storage system (S) and wherein the service life of the local storage system (S) is at least when the local storage system can no longer absorb and/or deliver a specific critical wattage due to the increase in internal resistance.

22. The device as claimed in claim 18, wherein an increase in internal resistance (r_h(t)) is determinable from the usage history (h([0,t])) and an usage history/increase in internal resistance model for the storage system (S) and wherein the service life of the local storage system (S) is at least when the local storage system can no longer absorb and/or deliver a specific critical wattage due to the increase in internal resistance.

23. The device as claimed in claim 19, wherein an increase in internal resistance (r_h(t)) is determinable from the usage history (h([0,t])) and an usage history/increase in internal resistance model for the storage system (S) and wherein the service life of the local storage system (S) is at least when the local storage system can no longer absorb and/or deliver a specific critical wattage due to the increase in internal resistance.

24. The device as claimed in claim 15, wherein the operational control parameters and/or control limits (p_r), which are to be conveyed using communications technology, for the local storage system (S) include at least one of the following values:
information about a maximum charging/discharging current limit,
information about minimum and maximum charging states for local operation,
a default value for a charging/discharging current, and
information about system service requirements.

25. The device as claimed in claim 16, wherein the operational control parameters and/or control limits (p_r), which are to be conveyed using communications technology, for the local storage system (S) include at least one of the following values:
information about a maximum charging/discharging current limit,
information about minimum and maximum charging states for local operation,
a default value for a charging/discharging current, and
information about system service requirements.

26. The device as claimed in claim 17, wherein the operational control parameters and/or control limits (p_r), which are to be conveyed using communications technology, for the local storage system (S) include at least one of the following values:
information about a maximum charging/discharging current limit,
information about minimum and maximum charging states for local operation,
a default value for a charging/discharging current, and
information about system service requirements.

27. The device as claimed in claim 18, wherein the operational control parameters and/or control limits (p_r), which are to be conveyed using communications technology, for the local storage system (S) include at least one of the following values:
information about a maximum charging/discharging current limit,
information about minimum and maximum charging states for local operation,
a default value for a charging/discharging current, and
information about system service requirements.

28. The device as claimed in claim 15, wherein the measured variables (p_l(t)) locally determined at the local storage system (S) include at least one measured value or time serie for the following variables: voltage frequency, voltage, spectra of the voltage and therewith the voltage frequency, locally generated current, locally consumed current, local state of charge, local charging/discharging current, electrical grid voltage and/or temperature at at least one location.

29. The device as claimed in claim 15, wherein the locally stored internal installation-dependent control limits (p_f(t)) include at least one maximum charging/discharging current and/or maximum and minimum charging states.

30. The device as claimed in claim 15, wherein an optimal charging/discharging current (cc(t)) can be approximated by a combination of a detailed short-term consideration within a first time interval ([t, t+Delta]) and a long-term consideration within a following second time interval ([t+Delta,L]).

31. The device as claimed in claim 30, wherein the short-term consideration comprises a short-term prediction of expected operational control parameters and/or control limits (p_r([t,t+Delta])) and a variation of the possible charging/discharging current progressions (cc([t,t+Delta])) under the condition of the predicted operational control parameters and/or control limits (p_r([t,t+Delta])) and the locally stored internal installation-dependent control limits (p_f(t)).

32. The device as claimed in claim 31, wherein the variation is performable by a weighted average of a set of randomly chosen progresses of charging/discharging currents (cc([t,t+Delta])) taking into account the predicted operational control parameters and/or control limits (p_r([t,t+Delta])) and the locally stored internal installation-dependent control limits (p_f(t)) and assigning higher weights to those representative progressions of charging/discharging currents with favorable cost function values.

33. The device as claimed in claim 30, wherein the long-term consideration within the second time interval ([t+Delta,L]) is performable by a combination of several representative cost functions within a time interval being shorter than the second time interval.

34. The device as claimed in claim 30, wherein the long-term consideration is performable on the basis of results of the short-term consideration.
